(19) United States
(12) Patent Application Publication
(10) Pub. No.: US 2018/0253989 A1
(43) Pub. Date: Sep. 6, 2018

(54) SYSTEM AND METHODS THAT FACILITATE COMPETENCY ASSESSMENT AND AFFINITY MATCHING

(71) Applicant: Samuel Gerace, Novelty, OH (US)

(72) Inventor: Samuel Gerace, Novelty, OH (US)

(21) Appl. No.: 15/911,030

(22) Filed: Mar. 2, 2018

Related U.S. Application Data
(60) Provisional application No. 62/467,123, filed on Mar. 4, 2017.

(51) Int. Cl. G09B 5/06; G06Q 10/06; G09B 19/00; G09B 5/14; G09B 7/02

(52) U.S. Cl. CPC G09B 5/065; G06Q 10/06393; G09B 19/003; A63B 24/0062; G09B 5/14; G09B 7/02; G09B 19/0038

(57) ABSTRACT

Various embodiments disclosed herein provide for a competency identification and analysis system and method. An individual's actions, interactions, and other data can be analysed to determine one or more competencies associated with the individual. The competencies can be identified using artificial intelligence, deep learning, and other techniques in order to identify skills, resources, strengths, and other advantages that an individual possesses. The system can then match the competencies to one or more tasks, jobs, mentors, and make recommendations related to these competencies. In an embodiment, the system can retrieve the contextual data from communications and interactions with other individuals, from education markers, job performance reviews, wearable devices. The system can also provide feedback to the individual, to have the user assess the competencies and rank the competencies or assessors who have provided the assessments. The feedback can be delivered in real-time, and in some embodiments via augmented reality devices.

### RELATED APPLICATION

The subject patent application claims priority to U.S. Provisional Patent Application No. 62/467,123, filed Mar. 4, 2017, and entitled, “SYSTEM AND METHODS THAT FACILITATE COMPETENCY ASSESSMENT AND AFFINITY MATCHING.” The entirety of the foregoing provisional patent application is hereby incorporated herein by reference.

### TECHNICAL FIELD

The subject disclosure relates to systems and methods that facilitate competency assessment and affinity matching.

### BACKGROUND

Identifying a competency of an individual is useful for both personal development and identifying matching or relevant opportunities. Current systems however do not fully incorporate all the available contextual data and analysis available in assessing competencies and matching affinities.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example block diagram of a competency identification and analysis system in accordance with various aspects and embodiments of the subject disclosure.

FIG. 2 illustrates an example block diagram of a competency identification and analysis system in accordance with various aspects and embodiments of the subject disclosure.

FIG. 3 illustrates an example block diagram of a competency identification and analysis system in accordance with various aspects and embodiments of the subject disclosure.

FIG. 4 illustrates an example block diagram of a competency identification and analysis system in accordance with various aspects and embodiments of the subject disclosure.

FIG. 5 illustrates an example block diagram of a competency identification and analysis system in accordance with various aspects and embodiments of the subject disclosure.

FIG. 6 illustrates an example block diagram of a competency identification and analysis system in accordance with various aspects and embodiments of the subject disclosure.

FIG. 7 illustrates an example block diagram of a competency identification and analysis system in accordance with various aspects and embodiments of the subject disclosure.

FIG. 8 illustrates an example method for identifying and analyzing competencies in accordance with various aspects and embodiments of the subject disclosure.

FIG. 9 illustrates an example block diagram of a computer system that can be operable to execute processes and methods in accordance with various aspects and embodiments of the subject disclosure.

FIG. 10 illustrates an example block diagram of a networking and computing environment in accordance with various aspects and embodiments of the subject disclosure.

### DETAILED DESCRIPTION

Various aspects of this disclosure are now described with reference to the drawings, wherein like reference numerals are used to refer to like elements throughout. In the following description, for purposes of explanation, numerous specific details are set forth in order to provide a thorough understanding of one or more aspects. It should be understood, however, that certain aspects of this disclosure may be practiced without these specific details, or with other methods, components, materials, etc. In other instances, well-known structures and devices are shown in block diagram form to facilitate describing one or more aspects.

Various embodiment disclosed herein provide for a competency identification and analysis system and method. An individual's actions, interactions, and other data can be analyzed to determine one or more competencies associated with the individual. The competencies can be identified using artificial intelligence, deep learning, and other techniques in order to identify skills, resources, strengths, and other advantages that an individual may possess. The system can then match the competencies to one or more tasks, jobs, schools, mentors, and make recommendations related to these competencies. In an embodiment, the system can retrieve the contextual data from communications and interactions with other individuals, from education records (e.g., test scores, grades, etc.), job performance reviews, wearable devices (e.g., physical data, interaction data, etc.) and other sources of information. The system can also provide feedback to the individual, to have the user assess the competencies and rank the competencies or assessors who have provided the assessments. The feedback can be delivered in real-time, and in some embodiments via augmented reality devices.

In an embodiment, a computer-implemented system can comprise a processor operatively coupled to a memory that comprises the following computer executable components. The components can include a communications component that receives and transmits data regarding an individual. The components can also include a context component that generate context regarding an individual. The components can also include a profile generation component that generates a profile regarding the individual. The components can also include a competency model component that employs artificial intelligence to assess a competency of the individual based at least in part on data regarding the individual, context of the individual and the individual's profile.

In another embodiment, a computer-implemented method can comprise management system can comprise using a processor operatively coupled to a memory to perform the following acts. The acts can include using a communications component to receive and transmit data regarding an individual. The acts can also include using a context component to generate context regarding an individual. The acts can also include using a profile generation component to generate a profile regarding the individual. The acts can also include using a competency model component that employs artificial intelligence to assess competency of the individual based at least in part on data regarding the individual, context of the individual and the individual's profile.

In another embodiment, a computer program product comprising a computer readable storage medium having program instructions embodied therewith, the program instructions executable by a processor to cause the processor to perform operations. The operations can include using a communications component to receive and transmit data regarding an individual. The operations can include using a context component to generate context regarding an individual. The operations can include using a profile generation component to generate a profile regarding the individual. The operations can include using a competency model component that employs artificial intelligence to assess competency of the individual based at least in part on data regarding the individual, context of the individual and the individual's profile.

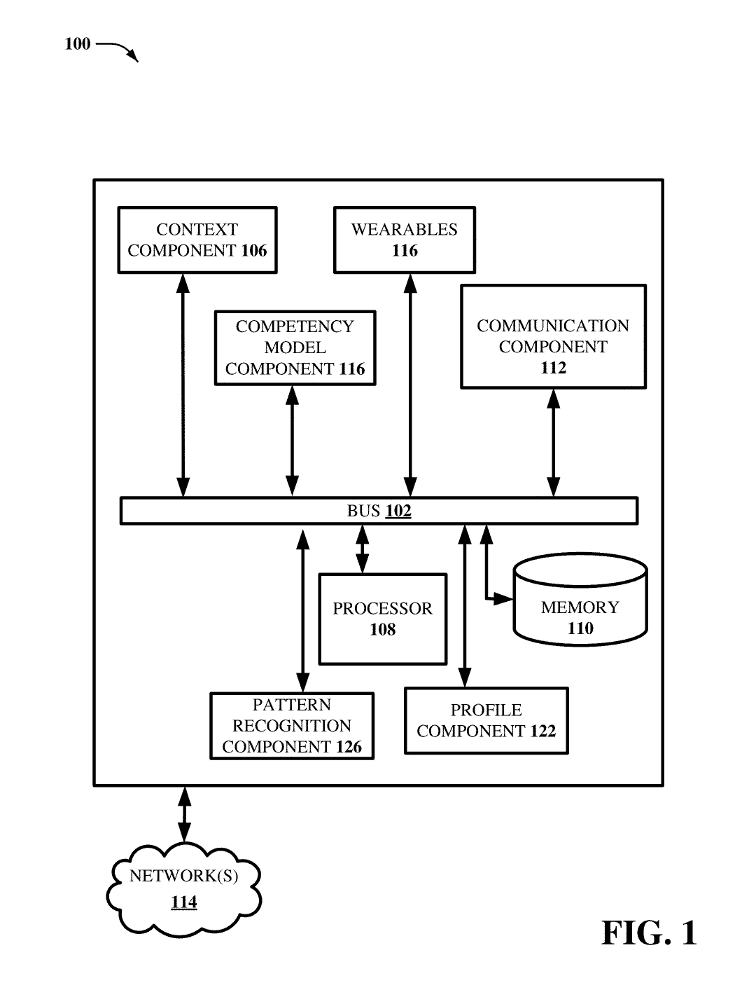

Turning now to FIG. 1, illustrated is an example block diagram 100 of a nonlimiting competency analysis system 100 that facilitates utilizing machine learning (or probabilistic modeling) to facilitate competency assessment and affinity matching in accordance with one or more embodiments described herein. Aspects of systems (e.g., non-limiting system 100 and the like), apparatuses or processes explained in this disclosure can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described.

In various embodiments, system 100 can be any type of mechanism, machine, device, facility, apparatus, and/or instrument that includes a processor and/or is capable of effective and/or operative communication with a wired and/or wireless network. Systems 100 can be implemented at least in part utilizing a variety of devices or appliances including but not limited to tablet computing devices, handheld devices, server class computing machines and/or databases, laptop computers, notebook computers, on-board vehicle computing devices or systems, desktop computers, cell phones, smart phones, consumer appliances and/or instrumentation, industrial and/or commercial devices, hand-held devices, digital assistants, multimedia Internet enabled phones, multimedia players, and the like.

The system 100 can include a bus 116 that can provide for interconnection of various components of the system 100. It is to be appreciated that in other embodiments one or more system components can communicate wirelessly with other components, through a direct wired connection or integrated on a chipset. The system 100 can include one or more wearable devices 116 that collect information regarding users, context, environment and associated devices. In some embodiments, a context component 106 can collect and provide contextual data regarding user(s) and environment. For example, context information such as what activity (e.g., running, swimming, having lunch, sleeping, drinking, etc.) in which an occupant was engaging can be determined and/or inferred.

The context component 106 can for example obtain context information from many different sources e.g., an occupant cell phone, calendar, email, GPS, appliances, third parties, the venue, etc. The system 100 can include a processor 108 and memory 110 that can carry out computational and storage operations of the system 100 as described herein. A communications component 112 can provide for transmitting and receiving information, e.g., through one or more internal or external networks 114 (wired or wireless networks). A competency model component 116 can be an explicitly and/or implicitly trained machine learning component trained to determine and/or infer user competency, action, affinities, etc.

The system 100 includes a profile component 122 that builds and stores in memory 110 user competency and affinity profiles. In an embodiment, the system 100 includes a pattern recognition component 126. A set of the sensors 122 can include cameras that collect image data inside and outside of a venue. The pattern recognition component 126 can be employed to identify users, collect facial expression information that can be analyzed by the competency model component 116 to assess state of users(s), e.g., tired, hot, cold, sleepy, alert, sad, happy, nervous, stressed, etc. Based on such determinations or inferences, the competency model component 116 can generate recommendations to facilitate user performance.

Artificial intelligence can be employed to match students and colleges based on competencies. The AI based system 100 can learn from student competencies and evidence (submitted work), learns from institutional messaging and from competencies of successful students at the college. The system 100 can allow access from either perspective, and accept a student competency profile and can return a list of college matches. The system 100 can accept a college's profile and return a list of (target) students. The system 100 can take an individual's current competency portfolio and a growth/learning plan, either personal or organizational (to get a promotion, qualify for a position, or get a credential.) Using AI, the system 100 can identify mastery/skill gaps in the targeted competencies.

In an example embodiment, the system 100 can use deep learning (as opposed to human specification) to determine what competencies are predictors of success for a given position or learning plan goal and identifies the gap between the individual's current portfolio and the goal requirements automatically. AI/deep learning assesses celebrities' competencies and identifies gaps between those and a user's competencies to guide development. Using a deep learning, system 100 can capture gaps in competencies at an organization and team level to show talent/learning/development needs.

In an implementation, competency portfolios of employees can be aggregated and analyzed using the deep learning system 100 along with organizational culture. The system 100 can use algorithmic determination of valuation for partners, acquirers, investors, (and comparison to market cap).

Using a wearable device 104, data on both athletic skills (physical data) and teamwork competencies (ex. emotional intelligence, using deep learning to assess their teammate interactions through the device) can be combined to create a total picture of an athlete as an asset to/on a team.

The system 100 can use advanced service matches skill/competency of a given player to the needs and culture of a team. Using deep learning, the system 100 can match individuals with mentors successful at developing specific competencies, values, and growth plans. Potential mentees can be reminded of competencies that they wish to develop (or that would be valuable to them) and are given suggestions for mentors appropriate for those competencies. Potential mentors can be reminded of competencies they've mastered and are given suggestions of possible mentees. The deep learning engine can provide questions to individuals to guide their thinking on competencies: where are they strong and where they have opportunity to grow, tied to one's interests and passions. In an implementation, the system 100 can track behaviors and biofeedback using wearables to assess competencies. The system 100 can use traditional and augmented reality methods to suggest interests and passions to guide questioning. A recommendation engine can then suggest learning tools/pathways, and could directly deliver those tools through augmented reality in real time. An AI engine helps people get the right level of challenge to keep stay in the state of “flow”.

The system 100 can authenticate when someone has met a certain level of social service. Authentication gives vendors the confidence to offer discounts to these individuals. The system 100 can extend the same philosophy to business to business. Businesses who meet certain level of social service receive discounts from other merchants. The system 100 can link to commerce systems and trade systems to automatically apply discount based on identity. Wearables can track someone's values, behaviors, competencies, and interests. The AI engine and system 100 can use this to identify matches. Using wearable gloves, or other wearables, individuals are assessed for competencies and skills like playing the piano, learning how to type, painting, playing golf, etc. Real time feedback is delivered through visual and wearable audio/physical augmented reality to guide cognitive and muscle memory learning.

The system 100 can accelerate moving repetitive tasks to lower-level technicians. (ex. surgical technicians can perform surgeries instead of doctors.) A complete competency profile-based deep-learning engine would allow the system to know what expert guidance is needed in the moment and when to offer it through augmented reality, and robots.

Using deep learning and wearable devices, the system 100 can provide real-time feedback to client service professionals from consumers on how their behaviors are mapping to expected competencies. Individuals can have an augmented reality persona which displays their individual competency development goals and automatically asks for feedback from others with whom the user is interacting whether physically proximate or remote.

The system 100 can provide for real-time and/or advance grouping of students and appropriate instructors based on desired competency development and current stage of mastery. Real time feedback (from communication tools like e-mail/slack/phone and/or wearables) on communication skills (both how you're articulating and how you're being perceived by the “other”) based on real-time AI can be provided.

The system 100 can use both wearables/AI/Bots/remote assessors with human-based assessment tools, provide individuals and teams with real time guidance and feedback on performance against identified ideal competencies. The system 100 can use AI/deep learning so that organizations and individuals can receive guidance on additional behaviors that could be added to evaluate a set of competencies (behaviors that the system has identified to support those competencies), output in the form of a rubric for assessors.

The system 100, through AI/machine learning make recommendations to individuals on competencies they need to develop. Through AI, provide individuals with a visual map of their competencies (ones that are were developed and others that are not) and show people their “competency shape”.

Using a wearable and deep learning the system 100 can filter feedback being given by another as being “useful” or “not useful”.

In an implementation, two-way feedback loop for learners and teachers can be provided by the system 100. Teachers give feedback and students give feedback on teachers as well. All this data can inform performance coaching for teachers/teacher workforce improvement. The system 100 can facilitate wearables and mobile devices facilitating instructors or students giving real-time feedback with a minimum of effort. The system 100 can add deep learning to provide direct feedback. Using AI, the system 100 can rank various “assessors” of competencies based on influence, credibility, knowledge, material. The system 100 can provide an “Assessor Marketplace” to allow individuals to engage an assessor for a desire competency. wearable device transmits proximity-based requests for feedback. The system 100 can add AI to listen to conversations and automatically requests the type of feedback. In an embodiment, an individual's learning can be aggregated in one place, and AI can be applied to help draw conclusions, make recommendations.

In accordance with additional embodiments and implementations, individuals can publish the IP/papers, etc, collected in their learning platform. Deep Learning technology can inform individual of ideas they have generated that are patentable/sellable. The system can enable individuals to check their list of competencies against what competencies an organization has/values/needs. Allows an organization to assess how an individual could enhance their organizational competency (fill gaps). The system 100 can facilitate deep-learning based auto-matching of individuals to organizations.

Individual competency portfolios allow organizations to evaluate based on competencies and real feedback, eliminate some bias from hiring process. The system 100 can use AI to assess which skills/competencies prove to predict superior performance in certain roles over time. The system 100 can determine role-specific competency profiles, and then evaluate candidates against that in hiring process.

Using augmented reality, physical schools could hold in-school sessions a few times a week and have students “learn from home” remotely the other days, pairing with classrooms from other countries, cities, etc, using augmented reality. Virtual classes would be assembled based on competency maps.

Using AI, the system 100 can map students' learning agenda to real world problems and opportunities, AI engine makes recommendations on pairs (students and business people, people in the community with problems/opportunities). Draw out for students how what they are learning connects to real world issues to help them find application for their learning in the real world (for example connecting algebra with architectural drawings). The system 100 can use AI match skills, learning style, competencies, and teaching styles to create ideal, balanced, high-performing teams.

Using AI/deep learning, the system 100 can match students' competencies, skills, interests, values, and motivations to employers' needed competencies/skills for various roles.

Using Virtual Reality/augmented reality, (eye lenses, glasses), the system 100 can allow students to “see” a day in the life of a professional in the job they aspire to, also use AI to match students with professions based on values, strengths, and competencies not just interest.

Using AI, the system 100 can match students with appropriate internships/apprenticeships based on competencies, strengths, values, and interests.

Assess competencies by using a wearable (eye lenses, glasses, etc) and deep learning to gauge emotion from others through facial recognition as an input to assessments on competency development. Wearable devices could be used to facilitate patient: doctor, student: teacher feedback or even self-feedback (wearable provides feedback (using biofeedback) to an individual on how they are communicating, how they are being perceived, and what their intrinsic motivations are).

In an implementation, the system 100 can use wearable devices and AI/deep learning to provide feedback to individuals on how they learn, what their strengths are then make recommendations to students on best schools/teachers for them. The system 100 can use virtual reality or augmented reality to increase empathy and global perspective by providing each student with a virtual experience of a kid in another country (“day in the life of”), pair children across countries for diverse learning experiences, and/or whole class could pair with another class. The system 100 can use wearable devices or an on-site device to capture feedback being given in the moment and associates it to an individual. The system can also use AI and machine learning to automatically match feedback to relevant portfolio competencies.

Through AI and deep learning (and perhaps a wearable to gauge activity and biometrics during activity), the system 100 can provide individuals with incisive questions to help them identify strengths, interests, and passions. Then provide recommendations on competencies to develop and where/how to develop them (pair them with other people resources, etc).

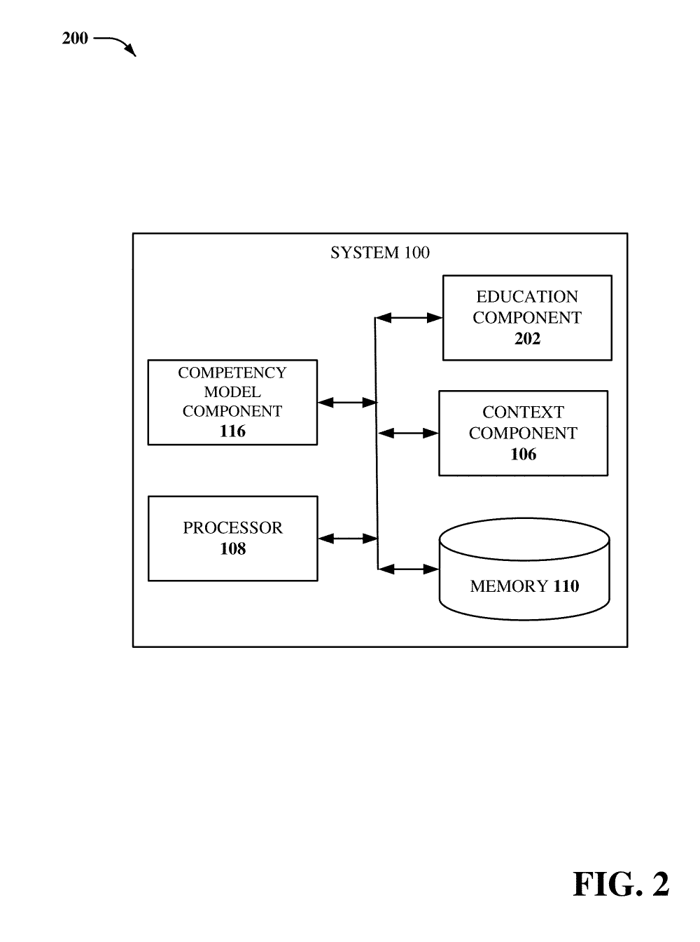

Turning now to FIG. 2, illustrated is an example block diagram 200 of a competency identification and analysis system 100 in accordance with various aspects and embodiments of the subject disclosure.

Education component 202 can assist context component 106 in generating contextual data about an individual which is used by competency model component 116 in generating and identified competencies associated with the individual by gathering educational data for context component 106. Education component 202 can communicate with one or more educational networks to gather data related to test scores, grades, homework, awards, degrees, and other educational data to generate educational context related to the individual. The competency model component 116 can analyze the education data and compare it to educational data from other individuals to determine the strength, weaknesses, and abilities of the individual.

In an embodiment, the education component 202 can also enable a feedback loop for learners and teachers. A teacher can give feedback related to the students, and the students can give feedback related to the teacher. This feedback can be collected by the education component 202 and used to generate competencies for the teachers and students. For instance, if a teacher does a good job teaching subject A, but doesn't do as well teaching subject B, as perceived by the students, the teacher's competency can be determined to be related to subject A, while subject B may be determined to be a weakness that can be used to guide development. This data can be used to guide teacher and student development. Wearables and mobile devices facilitate instructor or student giving real-time feedback with a minimum of effort. Advanced system would add deep learning to provide direct feedback.

The education component 202 can also match students and colleges based on the competencies. The education component 202 can compare the competencies of the students and university, and determine which students would be a good fit for a particular university. Likewise, the education component 202 can also make recommendations to an individual about which majors to pursue, what degree types, which classes to take, which professors to take based on the competencies of the student, and the competencies of the professors, class descriptions, degree and major requirements, and etc.

In an embodiment, the education component 202 can also facilitate tracking competencies and data to draw out for students how what they are learning connects to real world issues to help them find application for their learning in the real world (for example connecting algebra with architectural drawings).

The education component 202 can also match student's competencies, skills, interests, values, and motivations to employer's job requirements, required competencies, traits, and etc. for various roles. For instance, if an employer has an open position that requires a competency for X, and the student has a competency in X or a competency closely related to X, the education component 202 can suggest the student apply to the job. The education component can also use virtual reality, augmented reality etc., to allow students to “see” a day in the life of a professional in the job they aspire to and use AI to match students with professions based on values, strengths, and competencies not just interest. In an embodiment, the education component cal also use AI to match the students with internships and apprenticeships based on the competencies, strengths, values, and interests.

The education component 202 can also, via real-time, group students and appropriate instructors based on desired competency development and current stage of mastery of the subject being studied.

It is to be appreciated that the education component 202 can also perform these functions in reverse, by making hiring recommendations to the employers, and recruiting recommendations to the universities and colleges to hire or enroll students based on the matching competencies.

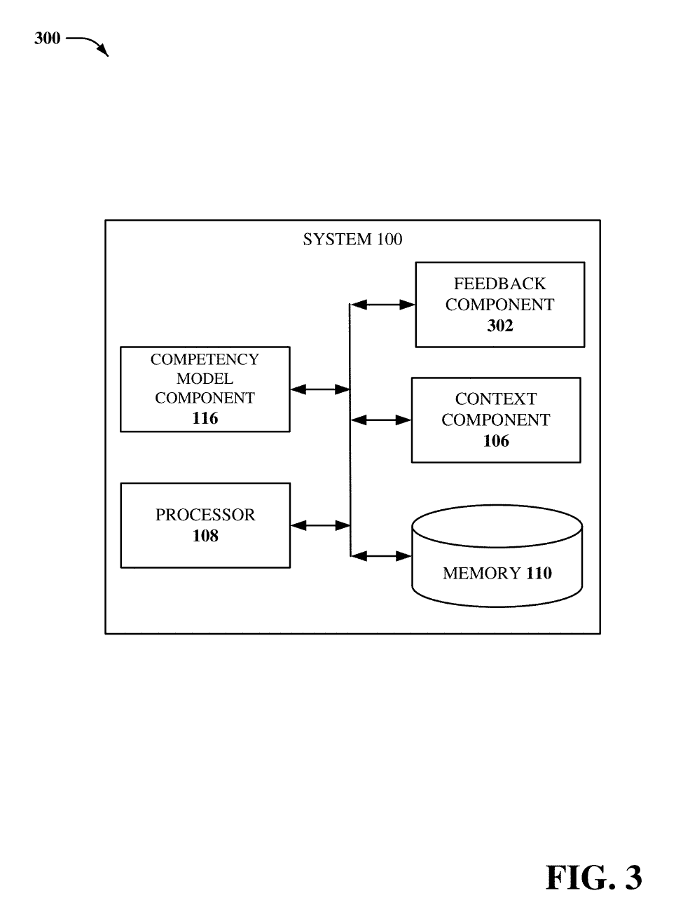

Turning now to FIG. 3, illustrated is an example block diagram 300 of a competency identification and analysis system 100 in accordance with various aspects and embodiments of the subject disclosure.

Feedback component 302 can assist context component 106 in generating contextual data about an individual and identified competencies which is used by competency model component 116 in identifying competencies and refining the competency identification model.

Feedback component 302 can in an embodiment communicate the competency identified by the competency model component 116 to the individual and receives feedback associated with the competency from the individual. In an embodiment, the feedback can be sent in an electronic communication to the individual or displayed on a screen (e.g., mobile device, computer screen, etc) and the individual can provide feedback related to the identified competencies. For instance, the individual may have a disagreement, agreement, or other opinion which can be used to refine the competency identification model. The competency model incorporates one or more different assessors, the feedback can also be used to rank the assessors based on influence, credibility, knowledge, material. The feedback component 302 can provide an “Assessor Marketplace” to allow individuals to engage an assessor for a desire competency.

In an embodiment, the feedback component 302 can also provide the individual with feedback via an augmented reality display (e.g., via augmented reality component 702). The individuals can have an Augmented Reality persona which displays their individual competency development goals and automatically asks for feedback from others with whom the user is interacting whether physically proximate or remote. The real-time feedback can be received via wearable devices or from email/slack/phone based on communications skills that include both objective assessments of how well the individual communicates and articulates thoughts, as well as subjective feedback received from other individuals to whom the individual is communicating.

The real-time feedback can also include real-time guidance and feedback on performance against identified ideal competencies via wearables, AI, bots, and remote assessors with human based assessment tools. The feedback can be for both individuals as well as teams.

The feedback component 302 can also use deep learning and wearable devices to provide real-time feedback to client service professionals from consumers on how their behaviors are mapping to expected competencies.

In an embodiment, the feedback component 302 can receive guidance on additional behaviors that could be added to evaluate a set of competencies (behaviors that the system has identified to support those competencies), output in the form of a rubric for assessors.

The feedback component 302, can in an embodiment, comprise a filter that can determine whether feedback is useful or not. In an embodiment, the filter can be based on AI or deep learning that learns from previous feedback given by the individual regarding competencies and feedback received from others.

In an embodiment, the feedback component 302 can receive feedback from wearable devices and other devices that transmits proximity-based requests for feedback. AI can be incorporated to listens to conversations and automatically requests the type of feedback based on the conversation and discussion items in the conversation.

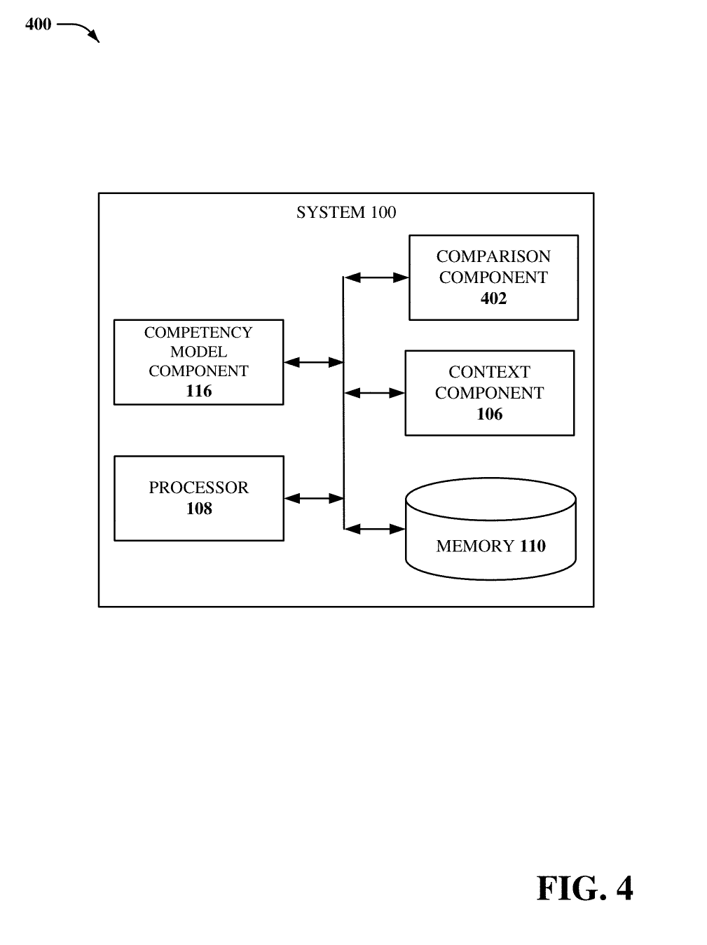

Turning not to FIG. 4, illustrated is an example block diagram 400 of a competency identification and analysis system 100 in accordance with various aspects and embodiments of the subject disclosure.

Comparison component 402 can make a comparison between the competency and a list of competencies associated with a group of organizations.

In an embodiment, the comparison component can compare the competency portfolios of all employees which are aggregated and analyzed using a deep learning system along with organizational culture. Algorithmic determination of valuation for partners, acquirers, investors, (and comparison to market cap) can be performed by the comparison component 402.

The comparison component 402 can assist the education component 202 in comparing the competencies of job seekers and students with the requirements and etc of employers and universities respectively.

In an embodiment, a wearable device (e.g., via wearables 116) can provide data on both athletic skills (physical data) and teamwork competencies (ex. emotional intelligence), and then use deep learning to assess team interactions via the wearable device. The data can then be used to generate a total picture of how the athlete, individual relates to the team on the whole, and provide information relating to the resources the athlete can bring to the team. The comparison component 402 can match the skill and/or competency of a given player to the needs and culture of the team, and be used by recruiters, sports team managers and others in order to make recommendations about building an improved sports team. For example, if a current team is lacking a player with a competency in X, then the comparison system cannot just locate a player who has a competency in X, but also compare the other competencies, emotional, physical, skills based and otherwise, in order to determine whether the player would be a good fit for the team.

In an embodiment, the comparison component 402 can also capture gaps in competencies at organization and team level to show talent, learning, and development needs of the individual or team. The comparison component can also assess celebrities' competencies and identifies gaps between those and a user's competencies to guide development of the individual.

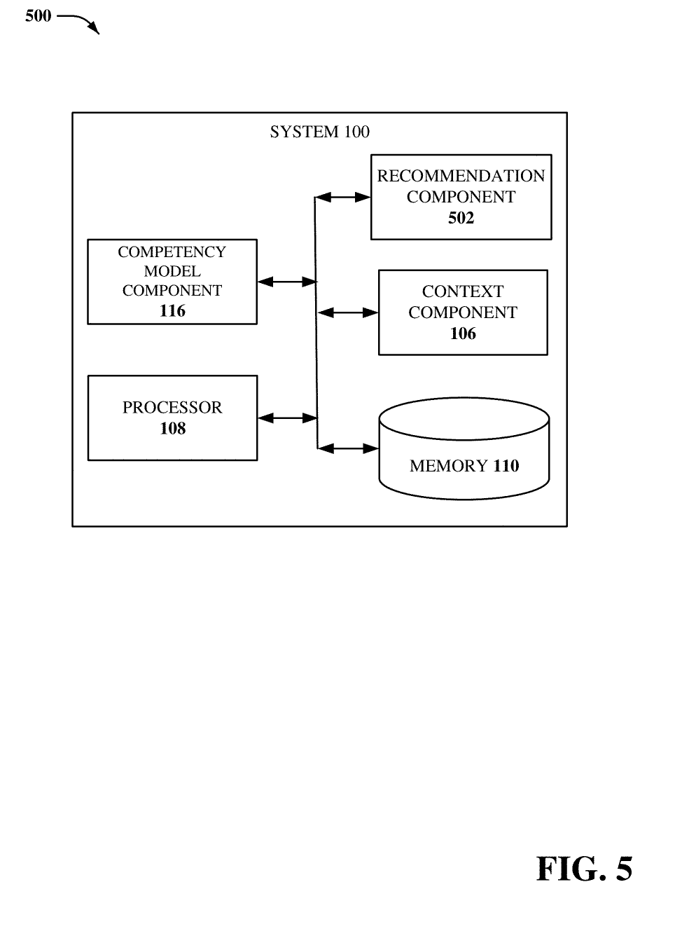

Turning now to FIG. 5, illustrated is an example block diagram 500 of a competency identification and analysis system 100 in accordance with various aspects and embodiments of the subject disclosure.

Recommendation component 502 can make a recommendation to the individual based on the comparison performed by the comparison component 402, wherein the recommendation comprises at least one of a job application recommendation, a school application recommendation, a class application recommendation, or team assembly recommendation. In an embodiment, the team assembly recommendation can be based on a function a learning style, competency, and or teaching style. It can also be based on the emotional IQ, physical playing style, and other intangibles identified by the deep learning algorithm.

In an embodiment, the recommendation component 502 can take an individual's current competency portfolio and a growth/learning plan, either personal or organizational (to get a promotion, qualify for a position, or get a credential.) Using AI, the system identifies mastery/skill gaps in the targeted competencies. Based on the skills gaps and skills/mastery identified, determine what competencies are predictors of success for a given position or learning plan goal and identifies the gap between the individual's current portfolio and the goal requirements automatically in order to improve the individual's chances of success.

In the educational context, the recommendation component 502 can use deep learning and AI to map students' learning agenda to real world problems and opportunities, AI engine makes recommendations on pairs (students and business people in the community with problems/opportunities). The recommendation component can also draw a map for students to show how what they are learning connects to real world issues to help them find application for their learning in the real world (for example connecting algebra with architectural drawings).

The recommendation component 502 can using AI match skills, learning style, competencies, and teaching styles to create ideal, balanced, high-performing teams and match students' competencies, skills, interests, values, and motivations to employers' needed competencies/skills for various roles including matching students with appropriate internships/apprenticeships based on competencies, strengths, values, and interests.

In another embodiment, the recommendation component can interface with the information received from wearable devices that can provide feedback to individuals on how they learn, what their strengths are then the recommendation component 502 can make recommendations to students on best schools/teachers for them. Similarly, the recommendation component 502 can provide individuals with incisive questions to help them identify strengths, interests, and passions. Then provide recommendations on competencies to develop and where/how to develop them (pair them with other people resources, etc).

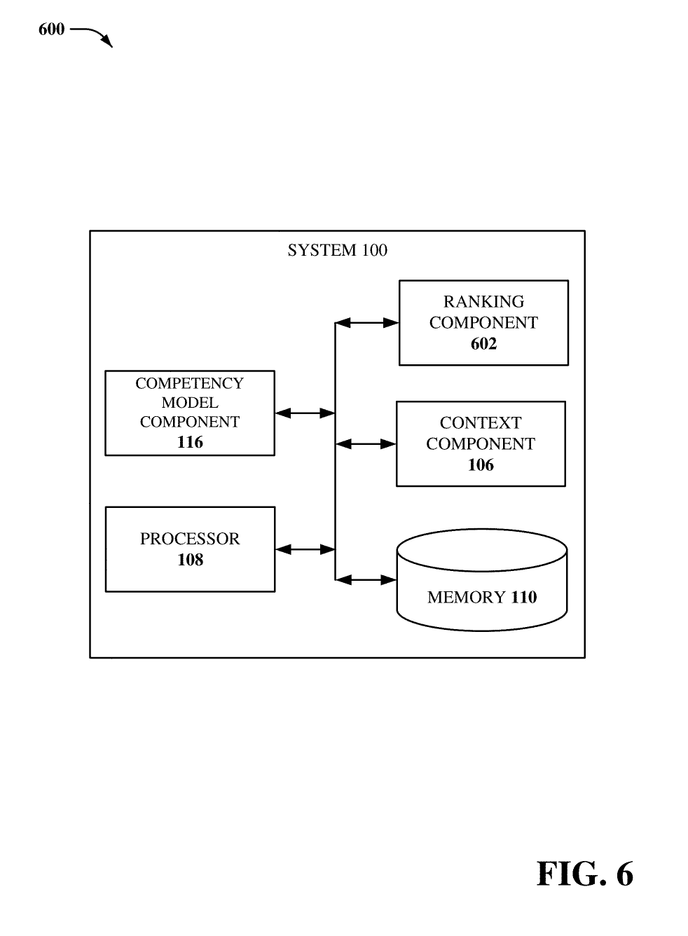

Turning now to FIG. 6, illustrated is an example block diagram 600 of a competency identification and analysis system 100 in accordance with various aspects and embodiments of the subject disclosure.

A ranking component 602 can be provided to rank a plurality of competency assessors based on a function of influence, credibility, and knowledge. The different competency assessors can correspond to different competency models that the competency model component 116 uses when identifying competencies, or can refer to external providers of competency assessments. The ranking component 602 can rank the providers based on feedback received via the feedback component 302 or via the augmented reality component 702. Based on the ranking, the competency model component 116 can determine a competency based on a function of competency models—using multiple competency models to determine an overall competency assessment, or meta-competency assessment.

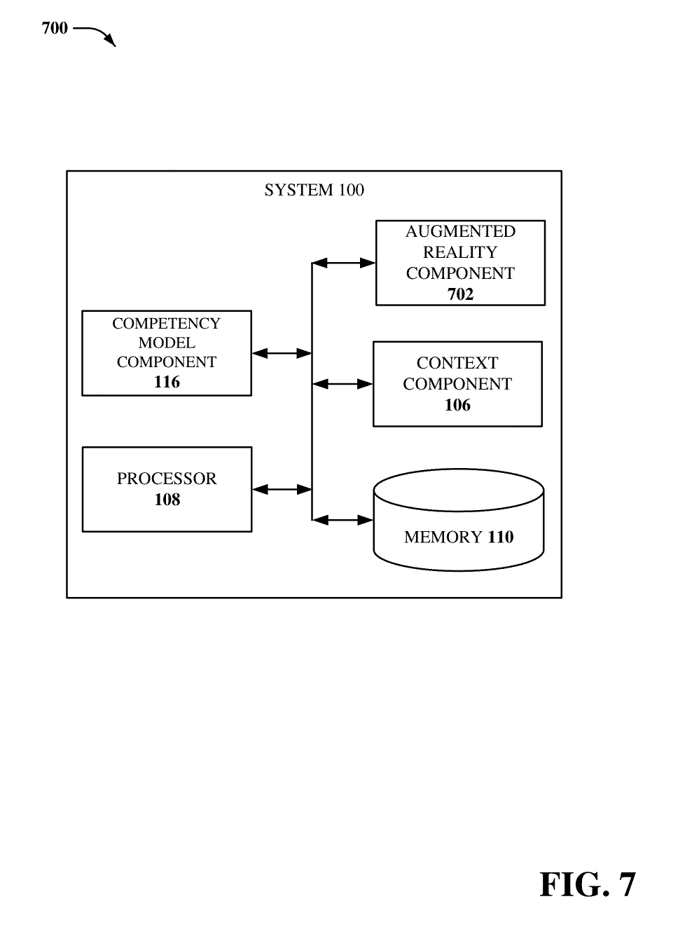

Turning now to FIG. 7, illustrated is an example block diagram 700 of a competency identification and analysis system 100 in accordance with various aspects and embodiments of the subject disclosure.

An augmented reality component 702 can be provided to interface with the feedback component 302 and recommendation component 402 in retrieving data from the surroundings and also interact with the individual by showing a display of competencies, recommendations, and also retrieve feedback from the individual about the recommendations, display, and etc.

In an embodiment, the augmented reality component 702 can communicates the competency to the individual in real time (e.g., via mobile device, ear phones, headset, virtual reality gear, and other augmented reality devices. In an embodiment an individual can have an augmented reality persona which displays their individual competency development goals and automatically asks for feedback from others with whom the user is interacting whether physically proximate or remote.

In another embodiment, the augmented reality component 702 can facilitate working with the education component 202 to use augmented reality in physical and virtual schools, holding in-school sessions a few times a week and have students “learn from home” remotely the other days, pairing with classrooms from other countries, cities, and etc. Virtual classes would be assembled based on competency maps, matching students with similar competencies in some embodiments, and matching students with disparate competencies in other embodiments to facilitate cross-competency learning and education.

In an embodiment, the augmented reality component 702 can also be used to facilitate increasing empathy and global perspective by providing each student with a virtual experience of a kid in another country (“day in the life of”). The augmented reality component 702 could facilitate pairing children across countries for diverse learning experiences, and/or whole class could pair with another class.

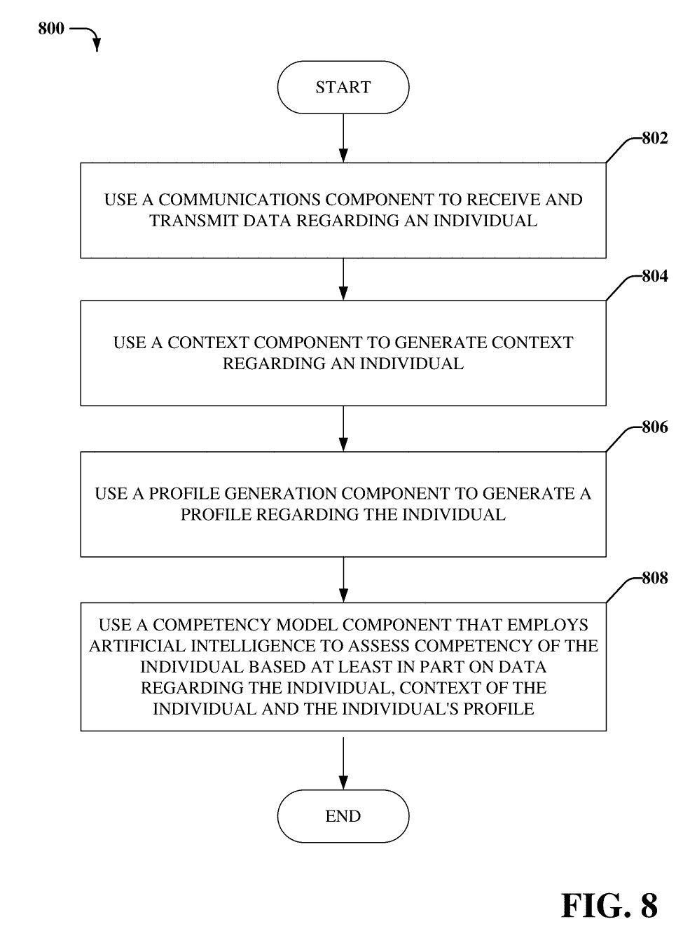

Turning now to FIG. 8, illustrated is an example method 800 for identifying and analyzing competencies in accordance with various aspects and embodiments of the subject disclosure.

In an embodiment, the method can start at 802 where the method includes using a communications component to receive and transmit data regarding an individual (e.g., by communications component 112).

At 804, the method includes using a context component to generate context regarding an individual (e.g., by context component 106).

At 806, the method includes using a profile generation component to generate a profile regarding the individual (e.g., by profile component 122).

At 808, the method includes using a competency model component that employs artificial intelligence to assess competency of the individual based at least in part on data regarding the individual, context of the individual and the individual's profile (e.g., by competency model component 116).

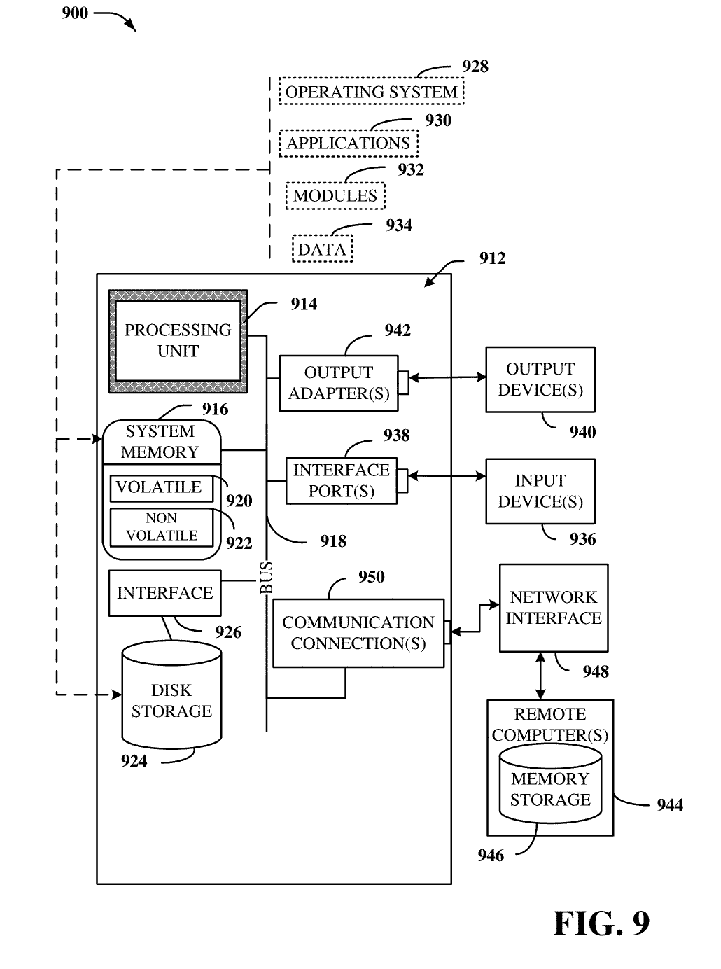

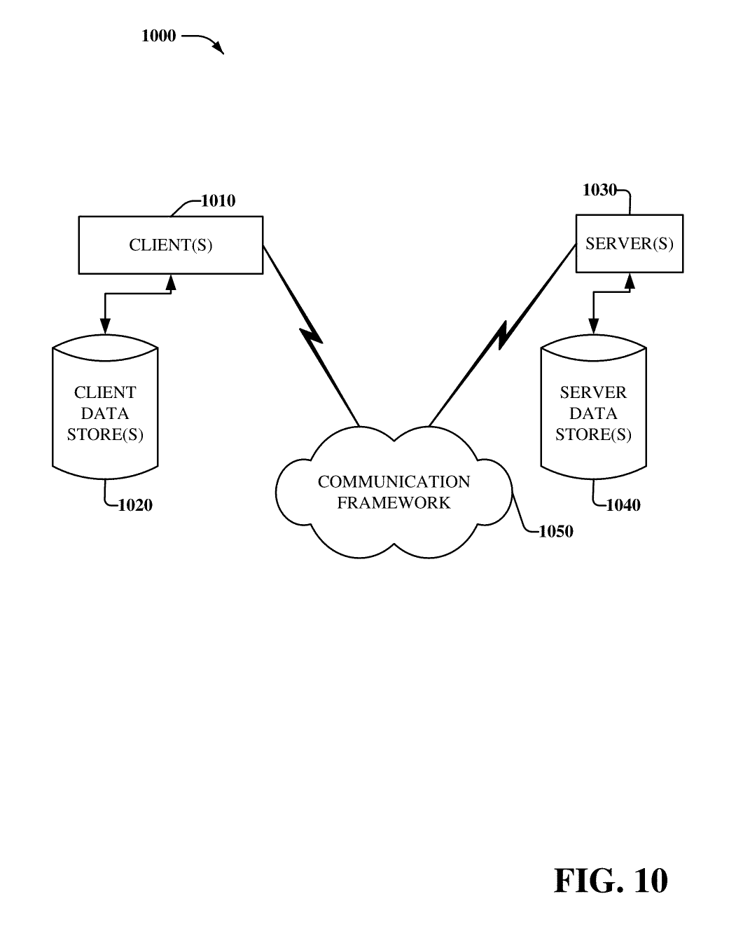

To provide a context for the various aspects of the disclosed subject matter, FIGS. 9 and 10 as well as the following discussion are intended to provide a brief, general description of a suitable environment in which the various aspects of the disclosed subject matter may be implemented.

With reference to FIG. 9, a suitable environment 900 for implementing various aspects of this disclosure includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1094), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), flash memory, or nonvolatile random-access memory (RAM) (e.g., ferroelectric RAM (FeRAM). Volatile memory 920 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 912 also includes removable/non-removable, volatile/non-volatile computer storage media. FIG. 9 illustrates, for example, a disk storage 924. Disk storage 924 includes, but is not limited to, devices like a magnetic disk drive, floppy disk drive, tape drive, Jaz drive, Zip drive, LS-100 drive, flash memory card, or memory stick. The disk storage 924 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used, such as interface 926.

FIG. 9 also depicts software that acts as an intermediary between users and the basic computer resources described in the suitable operating environment 900. Such software includes, for example, an operating system 928. Operating system 928, which can be stored on disk storage 924, acts to control and allocate resources of the computer system 912. System applications 930 take advantage of the management of resources by operating system 928 through program modules 932 and program data 934, e.g., stored either in system memory 916 or on disk storage 924. It is to be appreciated that this disclosure can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940, which require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 with which the subject matter of this disclosure can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing this disclosure, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. The client(s) 1010 are operatively connected to one or more client data store(s) 1020 that can be employed to store information local to the client(s) 1010. Similarly, the server(s) 1030 are operatively connected to one or more server data store(s) 1040 that can be employed to store information local to the servers 1030.

It is to be noted that aspects or features of this disclosure can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

Various aspects or features described herein can be implemented as a method, apparatus, system, or article of manufacture using standard programming or engineering techniques. In addition, various aspects or features disclosed in this disclosure can be realized through program modules that implement at least one or more of the methods disclosed herein, the program modules being stored in a memory and executed by at least a processor. Other combinations of hardware and software or hardware and firmware can enable or implement aspects described herein, including a disclosed method(s). The term “article of manufacture” as used herein can encompass a computer program accessible from any computer-readable device, carrier, or storage media. For example, computer readable storage media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or methods herein are intended to include, without being limited to including, these and any other suitable types of memory.

It is to be appreciated and understood that components, as described with regard to a particular system or method, can include the same or similar functionality as respective components (e.g., respectively named components or similarly named components) as described with regard to other systems or methods disclosed herein.

What has been described above includes examples of systems and methods that provide advantages of this disclosure. It is, of course, not possible to describe every conceivable combination of components or methods for purposes of describing this disclosure, but one of ordinary skill in the art may recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A computer-implemented system, comprising:
a processor operatively coupled to a memory that comprises the following computer executable components:
a communications component that receives and transmits data regarding an individual;
a context component that generate context regarding an individual;
a profile generation component that generates a profile regarding the individual; and
a competency model component that employs artificial intelligence to assess a competency of the individual based at least in part on data regarding the individual, context of the individual and the individual's profile.

2. The system of claim 1, wherein the communications component receives data regarding the individual from a wearable device.

3. The system of claim 1, wherein the data comprises data representing a physical activity of the individual.

4. The system of claim 1, wherien the data comprises data representing a communication of the individual and another individual.

5. The system of claim 1, wherein the competency model component determines affinity of the individual to a college or employed based in part on determined competency of the individual.

6. The system of claim 1, wherein the computer executable components further comprise:
an education collection component that collects education data about the individual, wherein the education data comprises homework data, test data, grades data, and awards data, and
wherein the competency model component asseses the competency based at least in part on the education data.

7. The system of claim 1, wherein the computer executable components further comprise:
a feedback component that communicates the competency to the individual and receives feedback associated with the competency from the individual.

8. The system of claim 7, wherein the computer executable components further comprise:
an augmented reality component that communicates the competency to the individual in real time.

9. The system of claim 7, wherein the feedback component matches the feedback to a related competency.

10. The system of claim 1, wherein the computer executable components further comprise:
a ranking component that ranks a plurality of competency assessors based on a function of influence, credibility, and knowledge.

11. The system of claim 1, wherein the computer executable components further comprise:
a comparison component that makes a comparison between the competency and a list of competencies associated with a group of organizations.

12. The system of claim 11, wherein the computer executable components further comprise:
a recommendation component that makes a recommendation to the individual based on the comparison, wherein the recommendation comprises at least one of a job application recommendation, a school application recommendation, a class application recommendation, or team assembly recommendation.

13. The system of claim 12, wherein the team assembly recommendation is based on a function of a learning style, competency, and teaching style.

14. A computer-implemented method, comprising:
using a processor operatively coupled to a memory to perform the following acts:
use a communications component to receive and transmit data regarding an individual;
use a context component to generate context regarding an individual;
use a profile generation component to generate a profile regarding the individual; and
use a competency model component that employs artificial intelligence to assess competency of the individual based at least in part on data regarding the individual, context of the individual and the individual's profile.

15. The method of claim 14 further comprising using one or more wearable devices that collect information regarding the individual.

16. The method of claim 14, wherein the competency model component determines affinity of the individual to a college or employed based in part on determined competency of the individual.

17. The method of claim 14, further comprising:
using a feedback component that communicates the competency to the individual and receives feedback associated with the competency from the individual.

18. The method of claim 17, further comprising:
using an augmented reality component that communicates the competency to the individual in real time.

19. A computer program product comprising a computer readable storage medium having program instructions embodied therewith, the program instructions executable by a processor to cause the processor to:
use a communications component to receive and transmit data regarding an individual;
use a context component to generate context regarding an individual;
use a profile generation component to generate a profile regarding the individual; and
use a competency model component that employs artificial intelligence to assess competency of the individual based at least in part on data regarding the individual, context of the individual and the individual's profile.

20. The computer program product of claim 19, wherein the program instructions are further executable by the processor to cause the processor to determine affinity of the individual to a college or employed based in part on determined competency of the individual.
